(19) United States
(12) Patent Application Publication
(10) Pub. No.: US 2026/0015000 A1
(43) Pub. Date: Jan. 15, 2026

(54) COMPUTER-IMPLEMENTED METHOD AND SYSTEM FOR CHECKING AND MODIFYING TRAJECTORY SUGGESTIONS FOR AN AUTOMATED OPERATING MODE OF A VEHICLE

(71) Applicant: Robert Bosch GmbH, Stuttgart (DE)

(72) Inventors: Johannes Christian Mueller, Stuttgart (DE); Heiko Freienstein, Weil Der Stadt (DE); Ralf Kohlhaas, Calw (DE)

(21) Appl. No.: 19/248,686

(22) Filed: Jun. 25, 2025

(30) Foreign Application Priority Data
Jul. 12, 2024 (DE) 10 2024 206 591.9

(51) Int. Cl. B60W 50/06; B60W 60/00

(52) U.S. Cl. CPC B60W 50/06; B60W 60/0011

(57) ABSTRACT

A computer-implemented method for checking and modifying trajectories suggested by at least one planning module for an automated operating mode of a vehicle. Situation-specific information is aggregated to ascertain at least one possible non-critical behavior of the vehicle, wherein each thus ascertained behavior is described by a set of boundary conditions. Based on the boundary conditions of the at least one ascertained behavior, the suggested trajectory is classified as critical or non-critical. At least when only critical trajectories are suggested, at least one of the critical trajectories is modified by selecting at least one of the ascertained non-critical behaviors as the target behavior and then modifying the critical trajectory such that it satisfies the boundary conditions of the target behavior at least in a given section.

### CROSS REFERENCE

The present application claims the benefit under 35 U.S.C. § 119 of German Patent Application No. DE 102024 206 591.9 filed on July 12, 2024, which is expressly incorporated herein by reference in its entirety.

### FIELD

The present invention relates to a computer-implemented method and a computer-implemented system for checking and modifying trajectories suggested by at least one planning module for an automated operating mode of a vehicle.

Such methods and systems are used in the context of behavior planning for partially or fully automated vehicles.

### BACKGROUND INFORMATION

Automated vehicles have to also operate in complex situations that sometimes change very quickly and unexpectedly. Appropriate behavior planning requires methods and systems that meet very high safety requirements. For this reason, systems with a multi- path architecture are often used in practice. A first path, the so-called performance path, comprises at least one planning module for generating trajectories that each describe a possible behavior of the automated vehicle for the given situation and can be implemented by the actuator system of the vehicle. These trajectories can be generated based on rules. However, planning modules that use artificial intelligence (AI) methods for trajectory planning are often used as well. To ensure that a trajectory suggestion from the planning module meets the requirements of the given situation and is also safe, this suggestion is checked and evaluated in a second path, the so- called safety path, by an independent further component. This component is also referred to as the "safety monitor".

In particular when none of the suggested trajectories meet the safety requirements of the given situation, the question arises whether and how such a critical trajectory can be corrected or modified to still solve the driving task.

### SUMMARY

A method according to an example embodiment of the present invention first analyzes the given traffic situation and for this purpose carries out the following method steps: aggregating situation-specific information and ascertaining at least one possible non-critical behavior of the vehicle based on the situation-specific information, wherein each thus ascertained behavior is described by a set of boundary conditions.

The at least one suggested trajectory is then classified as critical or non-critical based on the boundary conditions of the at least one ascertained behavior.

According to an example embodiment of the present invention, it has been recognized that such an analysis of the given traffic situation can not only be used for behavior planning and for classifying the suggested trajectories as critical or non- critical, but also opens up the possibility of "correcting" critical trajectories. According to the present invention, it has also been recognized that the boundary conditions ascertained during the analysis of the traffic situation can be used for a non-critical behavior to modify a trajectory suggestion that has been identified as critical in such a way that the modified trajectory suggestion is appropriate to the context of the traffic situation and can be used as the basis for controlling the actuators.

The method according to the present invention therefore provides modifying at least one of the critical trajectories, at least when only critical trajectories are suggested. For this purpose, at least one of the non-critical behaviors ascertained during the analysis of the traffic situation is selected as the target behavior for the trajectory to be modified. The trajectory to be modified is then modified such that it satisfies the boundary conditions of the target behavior at least in a given section.

According to an example embodiment of the present invention, it is therefore proposed that a trajectory classified as critical be modified "in the direction" of a target behavior which has been ascertained based on the aggregated situation-specific information and evaluated as non-critical. The "direction" of the modification stems from the boundary conditions that describe the target behavior.

It should be noted here that the method according to the present invention can also be applied if not all but only some of the trajectory suggestions of the at least one planning module are classified as critical.

In principle, within the framework of the method according to the present invention, any critical trajectory can be corrected or modified based on a non-critical target behavior. It is also possible to generate multiple different corrected trajectories in parallel from one critical trajectory by using different target behaviors as the basis for the respective modifications. This approach involves a greater amount of computing effort, however, and necessitates a selection step to ultimately determine the corrected trajectory to be implemented by the actuator system of the vehicle.

Overall, it proves to be advantageous to select the trajectory to be modified and the desired target behavior such that the effects on the overall system of implementing a respective modified trajectory are as minimal as possible.

In a preferred example embodiment of the method according to the present invention, a respective distance between the at least one critical trajectory and the at least one non-critical behavior is determined first. This involves the use of a predetermined distance metric, such as Voronoi diagrams or a penalty function, as a measure of how strongly a critical trajectory violates the boundary conditions of a non-critical behavior. The thus determined distances are then used as the basis for selecting the critical trajectory to be modified and selecting the associated target behavior. To keep the extent of the modification as small as possible, it is preferable that a pairing (critical trajectory to be modified, associated target behavior) with the smallest possible distance is selected.

The selected critical trajectory is preferably modified as part of an optimization process, and the boundary conditions of the associated target behavior are used as optimization criteria. Examples of possible approaches include a Hybrid A* search, a mathematical optimization with penalty functions for violating boundary conditions, or also heuristics with precalculated solutions.

According to an example embodiment of the present invention, the critical trajectory to be modified is modified such that it satisfies the boundary conditions of the target behavior at least in a given section. The modification according to the present invention can therefore affect the critical trajectory in its entirety or can also be limited to one or more trajectory sections. This is important in particular when the critical trajectory comprises critical and non-critical sections. Advantageously, the trajectory is corrected only from the latest possible time/waypoint of the trajectory, i.e. only from the time/waypoint at which the trajectory becomes critical. Only then does the trajectory curve need to be corrected. This avoids unnecessarily early intervention into the driving behavior. There is then also the possibility that the critical section of the trajectory to be modified is overwritten by a non-critical trajectory of the subsequent planning cycle. With a planning horizon of 3 s and a sampling frequency of 10 Hz, each trajectory suggestion includes 30 time/waypoints. At a replanning frequency of 10 Hz, each trajectory suggestion is overwritten by a trajectory suggestion from the subsequent planning cycle starting from the second time/waypoint. In this case, it proves advantageous to retain at least the first time/waypoint of a critical trajectory, provided this first time/waypoint is non-critical, and to limit the modification to only critical sections of the trajectory, specifically starting from the second time/waypoint at the earliest.

In a preferred embodiment of the present invention, the given traffic situation is analyzed with the aid of a surroundings model that is generated on the basis of situation-specific information. The possible behaviors of the vehicle are then ascertained using the surroundings model and the situation- specific information, wherein each behavior is described by a set of boundary conditions. In this embodiment, typically both non-critical and critical behaviors for the vehicle are ascertained. The classification as non-critical or critical is carried out using a predefined set of rules based on the boundary conditions of the respective behavior. In this case, the classification of the suggested trajectory as critical or non-critical is based on the classification of the possible behaviors, the boundary conditions of which the suggested trajectory satisfies or does not satisfy.

For such an analysis of the given situation, the so-called SOCA method can be used, for example, as presented in the paper M. Butz et al., "SOCA: Domain Analysis for Highly Automated Driving Systems," 2020 IEEE 23rd International Conference on Intelligent Transportation Systems (ITSC), 2020, pp. 1-6, doi: 10.1109/ITSC45102.2020.9294438.

The SOCA method is used to analyze traffic situations with the objective of determining boundary conditions or requirements for the behavior of an automated vehicle in the respective traffic situation. This involves first creating an abstract description of the traffic situation to be analyzed. This description uses so-called zone graphs. A zone graph abstracts the traffic situation to be analyzed by representing the real road situation using a corresponding abstract traffic infrastructure element (static road geometry) with different zones that are relevant to the realization of the driving intention of the vehicle under consideration but are initially specified neither in terms of their size nor in terms of their position. The different zones can represent different map regions, possible traffic flows, objects, etc. This abstract description of the traffic situation is then used to determine and morphologically analyze the possible developments or the behavior of the road users involved in order to determine boundary conditions for the behavior of the vehicle under consideration in the analyzed traffic situation. It is worth noting that the results or boundary conditions obtained in this way initially apply to all traffic situations with the same zone graph. Specification does not take place until the results are provided with the data of the situation-specific parameters of the analyzed traffic situation.

It proves particularly advantageous if the possible behaviors of the vehicle are prioritized based on the boundary conditions in conjunction with the predefined set of rules, so that this prioritization can be taken into account when selecting the at least one target behavior for the at least one critical trajectory to be modified. The prioritization ranks the possible behaviors of the vehicle ascertained for a given situation in an order that is determined by the predefined set of rules. This allows the behaviors preferred by the set of rules to be taken into greater account when modifying critical trajectories.

German Patent Application No. 102023 201 983.3 describes a method for prioritizing the possible behaviors of a vehicle based on the boundary conditions that define these behaviors and in conjunction with a predefined set of rules. The prioritization is automated here and is carried out dynamically during the runtime of the system. It does not require a special metric, but is based solely on a decision-process structure of the rule set.

In an advantageous further development of the method according to the present invention, the results of the classification and/or modification of a critical trajectory are made available to the planning component that suggested the trajectory. This feedback can be used to improve the performance of the planning component.

According to an example embodiment of the present invention, it also proves advantageous if trajectories classified as critical are temporarily stored or permanently stored in a log file together with the results of any modification. These data can then advantageously be used for documentation purposes. This is of particular interest, for instance, if an emergency occurred in which a critical trajectory was modified and then executed because the behavior planning did not find any non-critical alternatives as a recourse. The stored trajectory data can easily be used to reconstruct and explain such a decision. A safety justification for a decision made, i.e. the implementation of the modified trajectory in a specific traffic situation, can thus be supported.

The method according to an example embodiment of the present invention can furthermore also be used to trigger permanent storage of the continuously aggregated and cached situation- specific information when a critical situation has been identified because only critical trajectories were suggested and a critical trajectory was modified. These situation-specific data can then be used to better deal with critical situations in the future and ideally avoid them. For this purpose, the situation-specific information, in particular sensor data and internal status data, is temporarily stored in a circular buffer during ongoing operation. If a critical situation has been identified, the data of the circular buffer is transferred to a persistent memory, from which it can then be transmitted anonymously as soon as a stable data connection is established. A thus generated data set can be used for the further development and verification of automated driving functions, for example.

As mentioned above, the present invention relates not only to a computer-implemented method but also to a computer-implemented system for checking and modifying trajectories suggested by at least one planning module for an automated operating mode of a vehicle.

The system according to an example embodiment of the present invention comprises a perception layer for aggregating situation-specific information from vehicle-internal and vehicle-external information sources. The vehicle-internal information sources can be in-vehicle sensors, such as LiDAR sensors, radar sensors and/or RGB cameras installed on the vehicle, that acquire the surroundings of the vehicle, or sensors that acquire the status data of the vehicle, such as speed, orientation, etc. The vehicle-external information sources can be sensors, such as LiDAR sensors, radar sensors, and/or RGB cameras installed on infrastructure elements or other road users. Other possible sources of information include stored map information as well as retrievable weather and road condition information, traffic situation information, etc. The information from the different sources of information is aggregated by the perception layer and, if necessary, preprocessed into context information.

The system according to an example embodiment of the present invention further comprises an evaluation module for generating a surroundings model based on the aggregated situation-specific information and an analysis module for ascertaining possible behaviors of the vehicle based on the situation-specific information and the surroundings model, wherein each behavior is described by a set of boundary conditions.

The system according to an example embodiment of the present invention moreover has a predefined set of rules available to it, which is used to classify the possible behaviors as critical or non-critical based on their respective boundary conditions.

Another component of the system according to an example embodiment of the present invention is an evaluation module for classifying the suggested trajectories as critical or non- critical. This evaluation module is further designed to select at least one critical trajectory as the trajectory to be modified and to select at least one non-critical behavior as the target behavior for the trajectory to be modified.

The system according to an example embodiment of the present invention also comprises a repair module for modifying the trajectory to be modified such that it satisfies the boundary conditions of the target behavior at least in a given section.

The repair module can also be designed to generate a plurality of differently modified trajectories based on a critical trajectory by using different target behaviors as the basis for the respective modifications. In this case, the repair module is advantageously also designed to select at least one modified trajectory and make it available via at least one interface, in particular to a downstream control module and/or the planning module that suggested the trajectory.

In an advantageous further development of the present invention, the system according to the present invention further comprises at least one memory module for storing critical trajectories and the modified trajectories generated from them.

### BRIEF DESCRIPTION OF THE DRAWINGS

Embodiment examples and advantageous further developments of the present invention are explained in more detail in the following in conjunction with the figures.

FIG. 1 illustrates the measures according to an example embodiment of the present invention for checking and modifying trajectories suggested by a planning module in the context of behavior planning for a vehicle.

FIG. 2 shows a block diagram of a computer-implemented system according to an example embodiment of the present invention for checking and modifying trajectories suggested by at least one planning module for an automated operating mode of a vehicle.

### DETAILED DESCRIPTION OF EXAMPLE EMBODIMENTS

The starting point for behavior planning for an automated driving function of a vehicle traveling toward a specified destination is always the state of the traffic scene at a time of planning, and in particular the state of all of the participants in the traffic scene at the time of planning. The state of the traffic scene is described by situation-specific information that is aggregated at the time of planning, or also over a certain period of time before and up to the time of planning, from different vehicle-internal and/or vehicle- external information sources. For this purpose, the vehicle is typically equipped with a perception layer that includes the necessary sensors and usually also suitable data processing means.

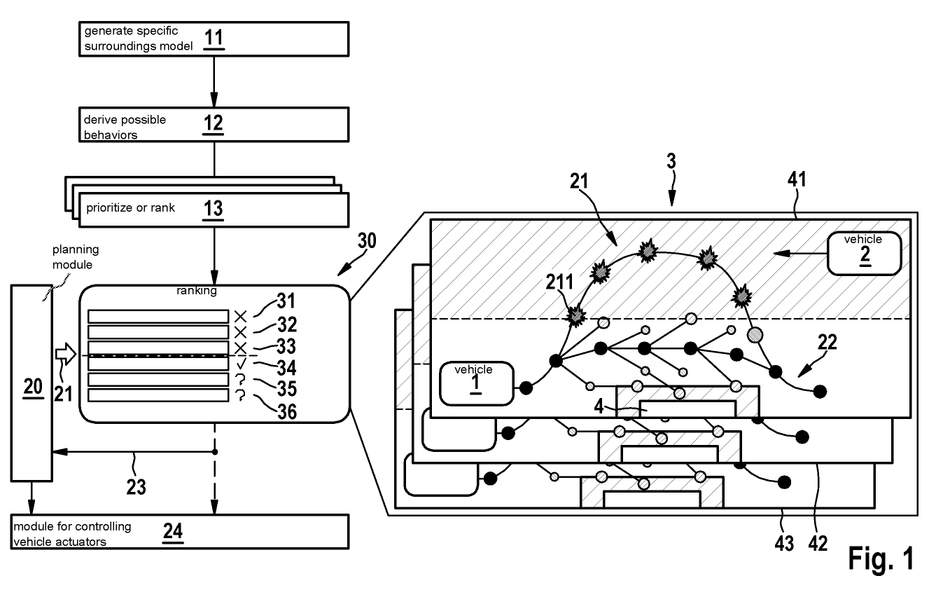

In the embodiment example described in connection with FIG. 1, a planning module 20 generates a trajectory 21 based on the specified destination and the aggregated situation-specific information, which is first checked with the aid of the method according to the present invention and classified as critical or non-critical.

For this purpose, the given traffic scene is first analyzed based on the specified destination and the aggregated situation- specific information. In a first analysis step 11, a specific surroundings model is generated. In the present case, this is an abstract description of the traffic situation in accordance with the aforementioned SOCA method. In a second analysis step 12, possible behaviors 31 to 36 of the vehicle for the given situation are derived from this abstract description of the traffic situation in conjunction with the situation-specific information, wherein each behavior 31 to 36 is described by a set of boundary conditions.

In the present embodiment example, these behaviors 31 to 36 are then prioritized or ranked in a third analysis step 13 using a predefined set of rules. The set of rules assigns semantics to the possible behaviors 31 to 36 and thus enables a prioritization based on a safety argumentation, wherein behaviors with increasingly relaxed boundary conditions are assigned ever-decreasing priority. The relaxation of the boundary conditions can be broadly grouped into the categories functional degradation, violation of traffic rules and endangering or harming road users. Functional degradation occurs, for example, when the vehicle is required to stop in front of an intersection instead of crossing it. A violation of traffic rules would be driving over a stop line because the vehicle can no longer brake in time, for example, or driving at excessive speed. An example of a relaxation of the category endangering or harming road users would be crash mitigation that accepts vehicle body damage to protect the lives of vulnerable road users.

FIG. 1 shows the result of the analysis step 13 in the form of a ranking 30 of behaviors 31 to 36, wherein the behaviors 31 to 36 are listed in descending order of priority.

The predefined set of rules was also used here to determine whether the respective behavior is considered non-critical (behaviors 31 to 33) or critical (behaviors 34 to 36). This distinction is indicated in FIG. 1 by the dashed dividing line in the ranking 30.

Critical behaviors are behaviors that either violate traffic rules or unreasonably hinder or even endanger other road users. Non-critical behaviors, on the other hand, differ in terms of comfort or the degree to which planning objectives are achieved. In an intersection situation, for example, crossing the intersection is given higher priority than stopping at the intersection, because crossing the intersection betters achieve the planning obejective. If the intersection is occupied, however, stopping at the intersection is a non-critical solution, because all of the traffic rules are being observed and other road users are not being unreasonably affected. However, if it is only discovered very late that the intersection is occupied at the time of crossing, so that the vehicle no longer stops in front of the intersection, but rather just inside it, this stopping behavior is classified as critical.

According to the present invention, the trajectory 21 suggested by the planning module 20 is classified as critical or non- critical based on the boundary conditions of the ascertained behaviors 31 to 36. In the embodiment example described here, the compatibility of the suggested trajectory 21 with the boundary conditions of the individual behaviors 31 to 36 was checked; specifically in the order of the ranking 30. This check was carried out here only up to and including the first behavior the boundary conditions of which satisfy the trajectory 21; specifically up to behavior 34. This means that the suggested trajectory 21 does not satisfy all boundary conditions of the non-critical behaviors 31, nor the non-critical behaviors 32 or 33 (symbolized by an x in the ranking 30), but only all boundary conditions of the first critical behavior 34 (symbolized by a checkmark in the ranking 30). The trajectory 21 is therefore classified as critical.

In the right half of FIG. 1, the trajectory 21 is again shown scenically in the form of a line 21 characterized by waypoints in a given traffic situation. It includes the vehicle 1, for which the trajectory 21 was proposed, and another vehicle 2. The two vehicles 1 and 2 are on a two-lane road 3, and are approaching an obstacle 4 in the lane of vehicle 1 from opposite directions. This results in two prohibited zones for vehicle 1: a first in the vicinity of the obstacle 4 and a second in the opposite lane in front of the approaching other vehicle 2. The prohibited zones are shown here cross-hatched. The trajectory suggestion 21 proposes driving around the obstacle 4 and moving into the opposite lane to do so despite the approaching vehicle 2. The trajectory 21 thus proceeds at least in sections in the opposite lane identified as a prohibited zone and has therefore been classified as critical.

This critical trajectory 21 is now "repaired" with the aid of the method according to the present invention, i.e. modified to a non-critical trajectory. This involves selecting at least one of the ascertained non-critical behaviors 31 to 33 as the target behavior. The critical trajectory 21 is then modified such that it satisfies the boundary conditions of the target behavior at least in the critical section, i.e. the section within the prohibited zone.

Usually, as also in the embodiment example described here, multiple non-critical behaviors 31 to 33 are available. The critical trajectory 21 can thus be corrected in the direction of one of these non-critical target behaviors.

In the embodiment example shown here, all of the non-critical behaviors 31 to 33 are selected as the target behavior in order to generate three different "repaired" trajectories based on the critical trajectory 21, specifically in parallel processing paths 41, 42 and 43. In the processing path 41, the modification of the trajectory 21 is based on the behavior 31 as the target behavior, in the processing path 42 the behavior 32 and in the processing path 43 the behavior 33.

Alternatively, it is also possible to select only one or a defined number of behaviors from the set of ascertained non- critical behaviors as the target behavior. For this purpose, a respective distance between the critical trajectory and the non- critical behaviors can be determined using a predetermined distance metric, such as Voronoi diagrams or penalty functions for violating boundary conditions of the respective non-critical behavior. The behavior closest to the critical trajectory, and thus with the highest expected chance of being able to be corrected, is then preferably selected as the target behavior. Selecting the target behavior advantageously also includes taking into account the prioritization of the ascertained behaviors by giving preference to behaviors with a higher prioritization.

The critical trajectory 21 is modified as part of an optimization process, wherein the boundary conditions of the selected non-critical behavior are used as optimization criteria. It is particularly advantageous here if the trajectory is corrected only from the latest possible time, i.e. ideally only from time/waypoint 211 that lies at the transition to the prohibited zone.

The correction can be based on a mathematical optimization, for example. For this purpose, rasterized distance maps can be generated for the distances between the critical trajectory and the respective target behavior, from which penalty functions are then derived. Alternatively, Voronoi diagrams can be calculated to determine the shortest distance between the critical trajectory and a region which, according to the target behavior, is valid and used as the basis for ascertaining a penalty function. It is also possible to use the critical trajectory as the starting solution of a parameter optimization problem, such as in a method according to Ziegler.

FIG. 1 shows a Hybrid A* search that explicitly searches for solutions within the boundary conditions of the target behavior. Preferably, all of the time/waypoints of the critical trajectory starting from the first violation of the boundary conditions of the target behavior (time/waypoint 121) are discarded. However, if desired or necessary, the Hybrid A* search can also start from an earlier time/waypoint and search for an alternative solution. Even when using a Hybrid A* search, a penalty term for deviations from the target behavior can be used. The resulting modified trajectory is labeled here as 22.

If the correction is successful, as in the embodiment example described here, the critical trajectory 21, together with its evaluation or classification as critical, and the corrected trajectory 22 are returned to the planning module, which is indicated by a feedback connection 23. The corrected trajectory 22 is also forwarded to a module 24 for controlling vehicle actuators. In the case of a critical input trajectory, this trajectory, its evaluation and possibly the associated corrected trajectory are furthermore recorded in a log file. Thus, the incident and the safety justification for the decision behind the input trajectory are documented.

The particular advantage of the method according to the present invention is that it not only identifies invalid or critical trajectories as such but also enables correction, which in many cases is more efficient than searching for a completely new trajectory.

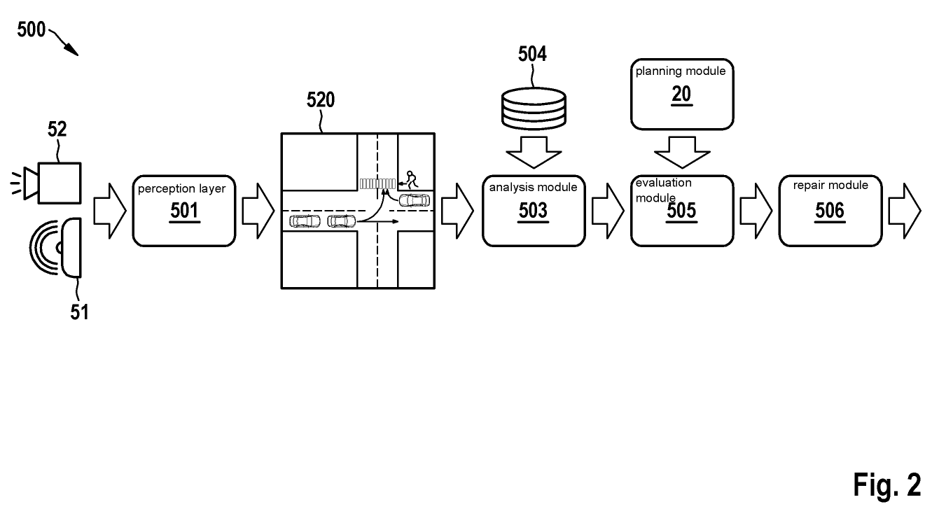

The block diagram of FIG. 2 illustrates the functions of the individual components of a computer-implemented system 500 according to the present invention and their interaction when checking and modifying trajectories suggested by at least one planning module 20 for an automated operating mode of a vehicle.

The system 500 comprises a perception layer 501 for aggregating situation-specific information from vehicle-internal and vehicle-external information sources. Shown examples of this are a vehicle sensor system 51 and infrastructure sensor system 52, the sensor data of which are collected and preprocessed by the perception layer 501.

The system 500 also comprises an evaluation module for generating a surroundings model 520 based on the situation- specific information. The analysis module is a component of the perception layer 501 here and is therefore not shown separately.

The surroundings model 520 is fed to an analysis module 503, which ascertains possible behaviors of the vehicle by inputting situation-specific information into the surroundings model 520. The analysis module 503 is designed such that it describes the ascertained behaviors using a respective set of boundary conditions for the behavior of the vehicle. In the embodiment example described here, the analysis module 503 also ranks the ascertained behaviors based on their respective boundary conditions and classifies them as critical or non-critical. A predefined set of rules 504 is available to the analysis module 503 for this purpose.

The ranking of behaviors of classified as non-critical or critical generated by the analysis module 503 is fed to an evaluation module 505. The evaluation module 505 uses this ranking to classify the trajectories suggested by the planning module 20 as critical or non-critical.

If multiple critical trajectories are suggested, the evaluation module 505 moreover selects at least one critical trajectory as the trajectory to be modified and at least one non-critical behavior as the target behavior for the trajectory to be modified. These are then fed to a repair module 506 that modifies the selected critical trajectory in the direction of the non-critical target behavior; specifically such that the boundary conditions of the target behavior are satisfied at least in a given section.

The repair module 506 can also be designed to generate a plurality of differently modified trajectories based on a critical trajectory by using different target behaviors as the basis for the respective modifications. In this case, the repair module 506 is usually also designed to select at least one modified trajectory and make it available via at least one interface, in particular to a downstream control module and/or the planning module 20 that suggested the trajectory.

What is claimed is:

1. A computer-implemented method for checking and modifying trajectories suggested by at least one planning module for an automated operating mode of a vehicle, the method comprising the following steps:
aggregating situation-specific information;
ascertaining at least one possible non-critical behavior of the vehicle based on the situation-specific information, wherein each of the at least one ascertained non-critical behavior is described by a set of boundary conditions;
classifying the at least one suggested trajectory as critical or non-critical based on the boundary conditions of the at least one ascertained non-critical behavior;
wherein at least when only critical trajectories are suggested, at least one of the critical trajectories is modified by:
selecting at least one of the at least one ascertained non-critical behavior as a target behavior, and
modifying the critical trajectory such that it satisfies the boundary conditions of the target behavior at least in a given section.

2. The method according to claim 1, wherein a respective distance between the at least one critical trajectory and the at least one non-critical behavior is determined using a predetermined distance metric, and the determined distances are used as a basis for selecting the at least one critical trajectory to be modified and for selecting the at least one associated target behavior.

3. The method according to claim 1, wherein the at least one of the at least one critical trajectory is modified as part of an optimization process, wherein the boundary conditions of the selected non-critical behavior are used as optimization criteria.

4. The method according to claim 1, wherein the critical trajectory includes critical and non-critical sections and the critical trajectory is modified only in critical sections.

5. The method according to claim 1, further comprising:
generating a surroundings model based on the situation-specific information;
ascertaining possible behaviors of the vehicle based on the situation-specific information and the surroundings model, wherein each of the ascertained possible behaviors s described by a set of boundary conditions;
classifying the ascertained possible behaviors of the vehicle as non-critical or critical based on the boundary conditions in conjunction with a predefined set of rules;
classifying the suggested trajectory as critical or non-critical by checking whether the suggested trajectory satisfies the boundary conditions of the ascertained possible behaviors.

6. The method according to claim 5, wherein the ascertained possible behaviors of the vehicle are prioritized based on the boundary conditions in conjunction with the predefined set of rules, and the prioritization is taken into account when selecting the target behavior for the at least one critical trajectory to be modified.

7. The method according to claim 1, wherein results of a classification and/or modification of a critical trajectory are made available to the planning component that suggested the trajectory.

8. The method according to claim 1, wherein trajectories classified as critical are stored in a log file together with results of any modification.

9. The method according to claim 1, characterized in that the aggregated situation-specific information is continuously cached and that this cached situation-specific information is permanently stored at least when only critical trajectories have been suggested and a critical trajectory has been modified.

10. A computer-implemented system for checking and modifying trajectories suggested by at least one planning module for an automated operating mode of a vehicle, the system comprising:
a perception layer configured to aggregate situation-specific information from vehicle-internal and vehicle-external information sources;
an evaluation module configured to generate a surroundings model based on the situation-specific information;
an analysis module configured to ascertain possible behaviors of the vehicle based on the situation-specific information and the surroundings model, wherein each ascertained possible behavior is described by a respective set of boundary conditions;
a predefined set of rules for classifying the possible behaviors as critical or non-critical based on their respective boundary conditions;
an evaluation module configured to:
classify the suggested trajectories as critical or non-critical, and
select at least one critical trajectory of the suggested trajectories as the trajectory to be modified, and at least one non-critical behavior as a target behavior for the trajectory to be modified; and
a repair module configured modify the trajectory to be modified such that it satisfies the boundary conditions of the target behavior at least in a given section.

11. The system according to claim 10, wherein the repair module is configured to generate a plurality of differently modified trajectories based on a critical trajectory by using different target behaviors as a basis for the modifications.

12. The system according to claim 10, wherein the repair module is configured to select at least one modified trajectory and make it available via at least one interface to a downstream control module and/or the planning module that suggested the trajectory.

13. The system according to claim 10, further comprising at least one memory module for storing critical trajectories and modified trajectories generated from the critical trajectories.
